(19) United States
(12) Patent Application Publication
(10) Pub. No.: US 2002/0169638 A1
(43) Pub. Date: Nov. 14, 2002

(54) System and method for providing wireless, paperless medical care and communication

(76) Inventor: Domingo Rodriguez-Cue, Williamston, NC (US)

Correspondence Address: JINAN GLASGOW, P O BOX 28539, RALEIGH, NC, 276118539

(21) Appl. No.: 09/852,358

(22) Filed: May 9, 2001

(51) Int. Cl. G06F 17/60

(52) U.S. Cl. 705/3

(57) ABSTRACT

An integrated, electronic patient record system and method for providing real time point of care evaluation, management, testing, data entry, billing, and treatment via wireless, paperless medical care processing. The system includes automatic data entry from clinical equipment, structured and non-structured examination protocol templates, synoptic patient chart view, cross-linked billing and diagnosis, digital generation of medical claims, point of care data entry and laboratory results. The present invention facilitates the generation of computerized prescriptions and transfer of same and/or electronic medical records to the patient or other medical entity for which the patient has provided consent where required.

### BACKGROUND OF THE INVENTION

(1) Field of the Invention

The present invention relates generally to electronic medical records and, more particularly, to an integrated, electronic patient record system for providing real time point of care testing, data entry, diagnosis, treatment and billing.

(2) Description of the Prior Art

A recent report by the Institute of Medicine estimated that as many as 98,000 people die in any given year due to hospital medical errors. That constitutes more fatalities than from motor vehicle accidents, breast cancer, or AIDS. Additionally, nonfatal errors can reduce the quality of life and add a financial burden to otherwise healthy persons. Adding the financial cost to the human tragedy, and medical errors easily rises to the top ranks of urgent, widespread public problems. The report noted that almost all the available information on safety relates to hospitals, and that far too little is known about other areas of care, like nursing homes, home health care, and office based care. It would be expected that hazards in these areas are also common.

Errors are seldom caused by carelessness or lack of effort. 95% to 98% of errors in medical care are “systems errors”, meaning that they are characteristics of equipment, procedures, job designs, or communication systems used in healthcare. Medication errors alone make up a large percentage of common avoidable problems. Designing systems that reduce error-prone procedures and establish proper methods can prevent errors. The development of effective systems at the level of direct patient care can thus prevent the majority of these errors. Electronic medical records (EMR) is one of these “systems”; it provides a number of tools, reminders, and system checks that can help providers reduce errors. It also allows for electronic prescription writing with remote links to pharmacies and/or hospitals and electronic orders that facilitate in-hospital patient care.

Prior art EMR systems employ various means to interface with the clinician. For example, Personal digital assistants, or PDAs, and desktop computers are commonly used. However, these methods of interfacing with the clinician are either difficult for the clinician to master and use or unsettling to the patient. In the case of PDAs, a limited amount of information is displayed to the clinician and therefore the clinician must retain in memory all information about the client or else he/she must continuously switch between data windows to refresh his/her memory. There is also no real time connection to the server allowing for true point of care medicine. In the case of desktop computers, these require the clinician to leave or turn away from the patient to input data, actions that may be unsettling to the patient, in that the patient may feel a lack of attention by the clinician. They also leave a window of opportunity for security to be breached at the client computer between uses. The desktop PC is not portable and is more costly to setup and maintain. Other systems have data inputted by the clinician but require transcribing, forward, or some other action by another person or party prior to transmission of the request. Thus, the possibility of error exists because another step performed by a person other than the clinician has been introduced into the system.

Another difficulty encountered in the integration of an EMR, laboratory, and billing systems is the integration of data from the various analytical devices used in clinical care. Manual inputting of information generated by these devices allows for errors to be introduced into records; however, direct communication between the various devices and the EMR is difficult to achieve because of the different connection protocols used by the devices. Manual inputting of data is also time consuming, in turn taking away precious patient care time. Manual input is also time-consuming in turn taking away precious patient care time.

Finally, many systems require additional inputting of previously recorded data into another format for the generation of invoices and bills. In these cases, errors such as double billing or missed billing can cause financial and legal problems for insurers and medical care providers alike. Thus, the prior art systems have properties that render them still error-prone or difficult to use and therefore unlikely to be widely adopted.

Thus, there remains a need for an electronic medical record system for providing real time point of care testing, data entry, billing, and treatment. The interface needs to be intuitive to medical personnel and easy to learn. It must be patient-centered, safe, effective, equitable, and efficient.

### SUMMARY OF THE INVENTION

The present invention is directed to an integrated, electronic patient record system for providing real time point of care testing, data entry, billing, and safe treatment.

The present invention is further directed to a method for using the integrated, electronic patient record system for providing real time point of care testing, data entry, billing, and safe treatment.

### DETAILED DESCRIPTION OF THE PREFERRED EMBODIMENTS

The present invention according to the preferred embodiment includes a data storage and processing device, or a server, connected via a wired and/or wireless local area network, or LAN, and/or wide area network, or WAN, to at least one portable computer and to clinical analytical equipment to provide real time point-of-care laboratory results, vital signs, patient history, examination assessment, plan, and billing. The server and clinical equipment can be connected via the wireless network or via a universal equipment-integrating device connector, such as the CARELINK universal connector by CARESIDE. The universal equipment-integrating device is capable of physically connecting to and receiving input from devices, such as analytical devices for the measurement of bodily functions and parameters. For example, the clinical equipment or analytical devices may include a vital signs monitor, digital cardiogram machine, a body composition analyzer to measure weight and percentage body fat, a blood chemistry analyzer, urine dip stick analyzer, IV pump, hematology analyzer, digital stethoscope, and any other laboratory or medical equipment that is capable of providing output in a digital electronic format or where the output is scannable or otherwise translatable or transferable into digital electronic format. Each device would capture real time data from the patient during the encounter and immediately transfer this data to the electronic patient record. The device could be located in the physician's office or at a distance, such as a nearby hospital.

Typically, these devices are equipped with in data input/output port, such as an RS232 port. The universal equipment-integrating device connects these devices to a mission critical file server that monitors data integrity and in turn communicates with the patient's electronic record. Alternatively, these devices can be connected directly to the server. For example, the server may be equipped with RS232 ports for direct connection to the analytical devices or these devices may be equipment with USB ports for connection with the USB ports of the server or client PC.

These clinical devices may provide such functions as testing, analysis, scanning, diagnosis, assessment, communication with the patient, prognosis, and treatment plan. Preferably, these results are automatically exported for incorporation into the patient electronic chart. These clinical devices may also cross-link various codes, such as bar-coded patient ID's, diagnosis codes, CPT codes and export these for incorporation into the patient chart. Bar coding or similar representation of information can route the patient ID key to their record, allowing for data capture relative to that patient. Bar coding can also allow for inventory of sample medicines or medical office materials inventory, thus facilitating ordering supplies, tracking medicines dispensed to a patient, and billing patient for these medicines. Additionally, the bar code can facilitate patient time and place tracking throughout the entire encounter. The mission critical file server consists of a data processor(s), data storage device(s), and data transmission device(s). The data transmission device(s) can include data lines, wireless transmission devices, and the like. An example of a wireless transmission device is a wireless LAN using routers operating at 2.4 Gigahertz using 802.1 1B protocol with the capacity to transmit at 11 Megabits/sec. The router can function as an access point within the local medical care facility or link to an external medical care facility or provider. For example, the server can transmit to a printer, electronic facsimile machine, portable computing device, and the like. Alternatively, the network can also use a wireless system that operates at another frequency, such as the RadioLan RF transmitter/receiver that operates at 5.8 GHz frequency. This allows for faster and less congested transmission of data. The data transmitted by these protocols is secure since it has 64 bit encryption capability. Only someone with a card that contains the encryption code can detect the signal. The fast access time allows for real time data capture during the patient encounter. The medical provider uses a touch screen capable notebook or subnotebook PC to allow for a faster, more intuitive system of data entry. By allowing for a range of 20 miles or more, medical facilities and providers can link together, thus sharing patient data and allowing for continuous access to the patient electronic record, or CAPER. This system would ultimately link doctors with the patient, nursing home, hospital, pharmacy and each other.

The LAN server runs software that allows it to communicate with and process information from a variety of devices, including the clinical devices, the portable computer, foreign servers, printers, communication devices, and the like.

The software also is capable of providing for data security, in that the software may encrypt selected data, may verify biometric data for user access to the network data, and may limit input and output of data. In a preferred embodiment, the system requires user login through a biometric device for access to the server and server functions. This would detect and deter intruders or unauthorized access.

Additionally, a preferred embodiment according to the present invention would assist with the framework for patient assessment, diagnosis, and treatment plan. By providing real time laboratory results, diagnosis can be made more quickly. Additionally, the software may be programmed to create templates using evidence-based medicine. These templates and reminder prompts facilitate optimal management of disease states such as cardiovascular disease, diabetes, cancer, and the like. To reduce medical prescription errors, a drop-down formulary acts as an aid to the clinician. The drop-down formulary allows the clinician to scan through the available pharmaceuticals and the like, select the item, further select the dose and other details of the prescription, and transmit the selected order to the appropriate pharmacist, service provider, patient, or the like. Thus, the system according to a preferred embodiment provides pass-through-prescription of goods and services. For example, the system may transmit prescriptions directly to a pharmacy and can also prescribe durable medical equipment and x-rays with linked codes for medical necessity. Additionally, the clinician can generate a billing charge from inside the note field. This process, know as pass-through-billing, is crucial to the medical encounter. Medicare demands that the medical provider be in charge of the billing process. In a preferred embodiment, the clinician selects a billing code for a particular treatment. The billing code is inserted into the note field. The insertion of the diagnosis code may be automatic upon request or completion of a service. For example, when the clinician requests a particular laboratory analysis, the system automatically inputs the billing code for the particular analysis into the note field. If the clinician double-clicks the CPT code, a secondary screen arises that will ask for a diagnosis code to link to the CPT code. If the two match the insurers criteria for that test, the process transfers to the medical note. The clinician simply highlights and clicks the BILL button or otherwise gives a BILL command to complete the process. The appropriate codes allowable by the insurer can be programmed prior to the transactions and preferably when the software is first setup. If the codes do not match, a prompt is given to the medical provider identifying potential disagreement with the insurance carriers policies on this order. Once in the chart, the two codes are linked and separated in brackets, such as [ ].

The clinician then highlights the billing and diagnosis codes and instructs the system to generate a transaction to the billing statement via a command, such as by tapping the Bill action button on the screen. The system then generates a billing charge that is ready for communication to the patient's insurance provider or to the patient. After a code has been billed, the system inserts a symbol proximal to the code to indicate that the code has been billed. For example, the system inserts a + in front of the code such that a code of 902 becomes +902.

Other fields in the form are filled out by the data fields that are already linked to the patient's chart since they were entered during the registration process. This process of pass-through-billing can assist with all types of billable codes, including x-ray procedures, evaluation and management, and durable medical equipment.

The server in a preferred embodiment according to the present invention may also provide for processing and communication of insurance claims to a foreign server. The insurance processing includes electronic billing, wherein the clinician selects and transmits insurance claim codes, such as a HCFA 1500 form to the appropriate insuring organization at the time of the medical exam. In the cases of patients with multiple medical problems, the clinician can order the priority of each treatment such that the most important treatment is claimed first. In this manner, the medical information does not need to be processed by other personnel and therefore the time requirements per patient are reduced and the possibility of error, including errors such as double billing, is greatly reduced. Additionally, billing of the insurance claim occurs in real time, thus reducing the time between delivery of service and reimbursement for service.

Other areas in the HCFA 1500 form are linked to and automatically filled in by data fields from the patient's chart, which were filled in during the registration process.

The server is connected to a lightweight portable computer. This connection may be via a hard line or via a wireless transmitter. In a preferred embodiment, the portable computer is a notebook computer that transmits to a server via a wireless transmitter and receiver. More particularly, the subnotebook computer is a B2130, commercially available from Fujitsu Corporation, and the wireless transmitter/receiver is a wireless RF transmitter/receiver operating at 2.4 GHz commercially available from Lucent Technologies Orinoco Line. An alternative device is the 5.8 GHz frequency RadioLan 140 PC card, commercially available from RadioLan Corporation. The long range wireless links can be point-to-point or point-to-multipoint. This linking can be done using Lucent Technologies CORs or RORs. These are connected to tower mounted antennas that transmit the signal over great distances. The routers also act as local access points providing local connections to the network. The routers and notebooks use access cards to bridge the signal. With this long range access the clinician is always connected to the patient's electronic record. If out of range, the data can be transmitted via encrypted Internet e-mail or via a patient mini disc carrying the entire chart. The record can also be printed into mini cards for patient portability of their record. The computer is portable in order to allow the physician to continue to face the patient when inputting data. Fixed computers may require the clinician to leave or turn away from the patient to input data. These actions may be unsettling to the patient, in that the patient may feel a lack of attention by the clinician. The portable computer also preferably includes a touch screen, thereby enabling the clinician to move between charts, open templates, make choices and the like by touching the screen. This function is important because it approximates the actions of a clinician when inputting data onto a paper chart or examining a patient. By approximating the paper chart method in this manner, a preferred embodiment according to the present invention allows the clinician to remain in a familiar state of mind, and not switch to another state of mind, one associated with using a mouse or computer keys to give commands to the computer. Thus, this and other features of the system make the performance and operation of the system intuitive to a physician practicing with a paper system.

A key element of the present invention is speed of data transfer. These computers and servers must operate at very fast speeds to allow for real time data entry and export. Flow of information from the patient, clinical equipment, and other data generators to the chart must be as close to real time as possible. This speed is only possible with very fast and optimally configured computers, routers, and networks. The patient must not feel that he or she is waiting for the computer to process a request of information. The computer should be almost silent and invisible to the patient. Thus, the keyboard should be quiet and the computer should not make any noise. The computer should also have optimal battery life and software to prolong battery life. In a preferred embodiment, the software generates visual screens that have a minimum of graphics. The graphical component of the screens is reduced in order to minimize the amount of time required to redraw a new screen when switching between screens. Quicker screen drawing allows for more rapid switching between screens, and less idle wait time for the clinician and patient.

The portable computer is capable of providing a template of a patient chart. The template or templates are of pivotal importance during the patient encounter. It can be provided by the software provider or can be created by the clinician. Thus, the system according to a preferred embodiment offers flexibility to the clinician such that he/she can select or create a template of his/her preference or customize an existing template. For these purposes, the software, either the portable computer software or the server software or both, includes an editor that can create and edit templates. The clinician must order the elements in the template keeping in mind optimal arrangement for data documentation both through the suggestion of the pertinent medical authority, such as AMA, and insurance provider organization, such as the HCFA. The template should also have the ability to increase equity for the clinician by assisting with optimal documentation. The order of the elements should also allow for optimal placement of the interface data from other office-based medical devices such as laboratory and vital signs data.

The template may be highly structured, providing a highly detailed examination protocol for the clinician to follow, such that the clinician is lead through the exam by the template, or it may be very loosely structured, such that the physician can proceed through the exam in the manner desired by the clinician. This second template, called a non-formatted, open note template, may be desirable for physicians who are not used to adhering to a protocol. Alternately, a physician can have multiple protocols from which he selects one to use based on a parameter, for example, the patient's insurance provider.

The template includes a note field, wherein the clinician and other personnel can enter observations. Data inputted into the note field is automatically presented in a time-based order. For example, the most recently inputted data appears at the top or bottom of the note field, according to the clinician's preference. The system is capable of providing the automatic importing of results and data from other sources into the template. For example, a consent form or data generated during a preliminary interview of the patient by another health professional may be imported.

In the preferred embodiment of the present invention, the system imports this data from other sources in a manner as to reduce the reading required by the clinician. For example, interview questionnaires export only the choices selected by the patient as being pertinent. These choices can be imported into the template in the appropriate field. Evidence-based medicine should play an integral part in updating the template or templates. These templates can also be shared with other physicians in the local and/or wide area network. Additional pertinent data, such as suggested diagnostic tests and/or test codes may also be imported and appended to the imported data. Thus, when a test is ordered or a medication prescribed, the order or prescription is documented.

Preferably and where required, these templates also allow for the patient to be followed via the wireless wide-area-network to other facilities where the templates allow for optimal care. The hospital charting and billing is done in the same chart. A daily progress note tracker will assist with compiling the patient's hospital stay and at the end create the discharge summary with the click off the summary button. The same drug formulary issued in the hospital so that when the patient returns to the office the same chart is used. The billing codes are entered in real time, facilitating optimal care. Additionally, the portable computer software offers a synoptic view of the template, including a demographic window, a vital signs window, a laboratory analyses window, a medications window, an allergies window, a family history window, a plan window, a prior visit window, and the like. Thus, the clinician has a simultaneous view of all the pertinent information for a single patient, and is not required to switch between windows to double-check patient facts. This is the same principle around which the cockpits of fighter jets are designed. . These windows may a have a drop down menu that allows the clinician to select a choice for one of the fields in the window. At a glance the doctor can see all the meds, all diagnosis, medical notes, jump to the insurance or demographics region.

These components and features combined form a wireless, paperless medical care system that is easy to use, always available, reduces data entry time and errors, and can provide real time point-of-care testing, data entry, treatment of patients and billing.

A method for using the system set forth in the foregoing is also included within the present invention. In a preferred embodiment, utilization of the system would involve a patient entering personal information directly through a workstation or by recitation to data entry personnel. The patient could also e-mail their medical information prior to the encounter. Such information can include age, allergies, symptoms, family history, and the like. This is the primary triage area. The patient's digital picture and signature are also obtained at this point and entered into the patient's electronic medical records. Next, appropriate analytical devices determine the patient's vital signs such as blood pressure, heart rate, height, weight, and the like. Any blood testing that has been ordered prior to the visit can also be done and linked electronically to the patient's chart. This is the secondary triage area. The use of equipment made for point of care testing like the CARESIDE analyzer play an integral part in this step. Next, the clinician evaluates and examines the patient. As the patient speaks, data is captured by the clinician with the keyboard and entered into the patient's electronic medical records. The templates are used for optimal examination and documentation.

Certain modifications and improvements will occur to those skilled in the art upon a reading of the foregoing description. By way of example, the system according to the present invention is not limited to use in clinics and hospitals, but can be used in nursing homes, dentist's offices ambulances, ships, airplanes, etc. Also, non-medical and administrative information pertaining to the patient can also be electronically stored and transferred within this system, including but not limited to, patient insurance cards, patient consent, and the like. All modifications and improvements have been deleted herein for the sake of conciseness and readability but are properly within the scope of the following claims.

I claim:

1. A system for providing wireless, paperless medical care, comprising a server running software connected to a network which provides connection for communication, including transmitting and receiving information and data electronically with at least one portable computer running software; the server further being connected to clinical equipment for receiving data including test results from the clinical equipment; thereby providing real-time point-of-care laboratory testing, data capture and entry, treatment of patients, and billing.

2. The system of claim 1 wherein the clinical equipment is integrated with the server via a universal equipment-integrating device.

3. The system of claim 1 wherein the portable computer software includes at least one template for patient charts.

4. The system of claim 3, wherein the at least one template includes multiple database fields from patient records.

5. The system of claim 3, wherein the at least one template includes multiple data charts.

6. The system of claim 5, wherein the at least one template includes a synoptic view of the multiple data charts.

7. The system of claim 3, wherein the at least one template is an editable template.

8. The system of claim 3, wherein the at least one template is a customizable template that helps to build office and hospital notes including discharge summaries.

9. The system of claim 3, wherein the at least one template includes pull down lists for quick selection for template items insertion into the template.

10. The system of claim 3, wherein the at least one template is multiple template.

11. The system of claim 3, wherein the at least one template is a non-formatted open structure template.

12. The system of claim 3, wherein the at least one template builds a discharge summary.

13. The system of claim 12, wherein the discharge summary is built from the daily summaries.

14. The system of claim 3, wherein the at least one template includes automatic integration of electronic medical records and pass through billing with code linking.

15. The system of claim 3, wherein the at least one template includes automatic importing of data from other components of the system.

16. The system of claim 1, wherein the portable computer includes a touch screen.

17. The system of claim 1, wherein the server is connected to a local area network.

18. The system of claim 1, wherein the server is connected to a wide area network.

19. The system of claim 1, wherein the server is connected to a local area network and wide area network

20. The system of claim 1, wherein the server is a mission critical file server

21. The system of claim 1, wherein the server software provides security.

22. The system of claim 21, wherein the security includes data encryption.

23. The system of claim 22, wherein the encryption requires login for de-encryption.

24. The system of claim 21, wherein the security is biometric security.

25. The system of claim 21, wherein the security limits access to information input and output.

26. The system of claim 21, wherein the access to information input and output requires login.

27. The system of claim 1, wherein the server software provides at least one formulary.

28. The system of claim 27, wherein the at least one formulary is a drop down formulary.

29. The system of claim 1, wherein the server software provides diagnosis code lists.

30. The system of claim 1, wherein the server software provides aid with formulating and assessment and treatment plan.

31. The system of claim 1, wherein the server software provides insurance processing.

32. The system of claim 31, wherein the insurance processing includes pass-through-billing.

33. The system of claim 31, wherein the insurance processing includes billing prioritization.

34. The system of claim 34, wherein the insurance processing includes pass-through-prescribing.

35. The system of claim 34, wherein the insurance processing includes claims codes.

36. The system of claim 1, wherein the clinical equipment provides functions selected from the group consisting of testing, analysis, scanning, communication with patient, and combinations thereof.

37. The system of claim 1, wherein the clinical equipment provides functions selected from the group consisting of assessment, plan, and combinations thereof.

38. The system of claim 1, wherein the clinical equipment generates result codes that are cross-linked by the server software with codes selected from the group consisting of diagnosis codes, laboratory codes, billing codes, and combinations thereof.

39. A template for entering and viewing electronic medical records, comprising:
a fast load time;
a capture of HCFA format;
an automatic importing of demographic information into corresponding fields within the template;
a review of systems template;
quick addition of subtemplates into a note field within the template;
use of a diagnosis list in conjunction with the past medical history for a given patient's electronic medical records;
a list of medications;
a list of patient vital signs and laboratory values that are electronically stored within the patient's electronic medical records;
a pass through billing with automatic code linking;
a within-the-note diagnosis and a diagnosis ranking
a recording of above diagnosis;
a recording of medication changes;
a recording of durable medical equipment and x-ray orders;
cut and paste features;
a discharge feature for assisting with creating a hospital discharge summary;
an interface with a universal equipment-integrating device for linking for electronic communication with other office equipment and clinical testing equipment, wherein all the features are viewable on a computer screen.

40. The template of claim 39, wherein the demographic information includes the patient's name, age, sex, employment, allergies, race, and combinations thereof.

41. A method for using a system for providing wireless, paperless medical care to a patient with real-time point-of-care testing, comprising the steps of:
providing a primary patient triage that includes initial encounter, which provides initial encounter information that is entered into the patient's electronic medical records, which are stored on a server and accessible via at least one remote computer;
providing a secondary triage that produces secondary encounter information that is entered into the patient's electronic medical records;
providing a clinical encounter with at least one medical care provider that produces clinical encounter information, including clinical equipment test results, which is entered into the patient's electronic medical records;
providing interpretation and management of the patient's electronic medical records;
providing treatment plan formulation that is entered into the patient's electronic medical records;
and providing pass-through billing and insurance processing using the electronic medical records and the system, thereby providing real-time point-of-care laboratory testing, data capture and entry, treatment of patients, and billing.
